(19) United States
(12) Patent Application Publication
(10) Pub. No.: US 2009/0010144 A1
(43) Pub. Date: Jan. 8, 2009

(54) Transducer Assembly and Data Storage Apparatus Including the Transducer Assembly

(75) Inventors: Earl Chrzaszcz Johns, Sewickley, PA (US); Corina Nistorica, San Jose, CA (US); Martin Gerard Forrester, Murrysville, PA (US); Jay Zhao, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/772,409

(22) Filed: Jul. 2, 2007

(51) Int. Cl. G11B 7/00; G11B 5/127; G11B 5/147

(52) U.S. Cl. 369/126; G9B/7

(57) ABSTRACT

An apparatus includes a storage medium, a transducer including an electrode positioned along an axis and having a curved end positioned adjacent to the storage medium, a wear-resistant coating surrounding the electrode, and an actuator for providing relative movement between the storage medium and the transducer.

### FIELD OF THE INVENTION

This invention relates to data storage devices and, more particularly, to probe-type data storage devices and transducer assemblies for use in probe storage devices.

### BACKGROUND OF THE INVENTION

Probe storage devices have been developed to provide small size, high capacity, low cost data storage devices. Probe recording requires relative movement between a storage medium and an array of transducers that are used to subject the storage medium to electric or magnetic fields. The storage medium can be a planar thin film structure.

Relative movement and friction between the transducers and the storage medium causes wear in both the transducers and the storage medium. The transducer contact area induces a concentrated stress zone in the storage medium that promotes storage medium wear. Although there are many factors that can lead to storage medium wear, having sharp transducer tips with high stress points is a contributing factor to unacceptable storage medium wear.

In order to use low cost lithography, lever probes have been proposed, where the thickness of a metal electrode film in the transducer defines a track width. Data is written and read with the transducer moving in the transverse direction with respect to the track. The written and read tracks may not line up when data is written in the transverse direction.

Actuators that are used to effect relative movement between the transducers and the storage medium can result in coupling forces transmitted to the storage medium in a direction other than the intended direction of motion. For example, a force applied to move the storage medium in the X-direction can also cause movement in the Y-direction or the Z-direction, which creates off-track motion and affects the overall device accuracy. In addition, Z-direction movement can cause tilting of the lever transducers that may result in loss of contact between the transducer electrode and the storage medium.

There is a need for a transducer assembly that reduces wear and maintains contact between the transducer and the storage medium.

### SUMMARY OF THE INVENTION

In a first aspect, the invention provides an apparatus including a storage medium, a transducer including an electrode positioned along an axis and having a curved end positioned adjacent to the storage medium, a wear-resistant coating surrounding the electrode, and an actuator providing relative movement between the storage medium and the transducer.

In another aspect, the invention provides an apparatus including a storage medium, a transducer mounted on a symmetric suspension and positioned adjacent to the storage medium, and an actuator providing relative movement between the storage medium and the transducer. The suspension can comprise a base and a plurality of spring arms extending radially from the base to a frame. The spring arms can lie along mutually perpendicular axes.

In another aspect, the invention provides an apparatus including a transducer including an electrode positioned along an axis and having a curved end, a wear-resistant material surrounding the electrode, and a symmetric spring assembly supporting the transducer.

### BRIEF DESCRIPTION OF THE DRAWINGS

FIG. 1 is a perspective view of a probe storage device that can be constructed in accordance with an aspect of the invention.

FIG. 2 is a cross-sectional view of a probe storage device constructed in accordance with an aspect of the invention.

FIG. 3 is a schematic representation of a transducer and an adjacent storage medium.

FIGS. 4 and 5 are schematic representations of a transducer tip and an adjacent storage medium.

FIG. 6 is an isometric view of a transducer assembly constructed in accordance with an aspect of the invention.

FIG. 7 is a cross-sectional view of the transducer assembly of FIG. 6.

FIG. 8 is a plan view of the spring of the transducer assembly of FIG. 6.

FIG. 9 is an isometric view of a transducer having an end with a cylindrical curvature.

### DETAILED DESCRIPTION OF THE INVENTION

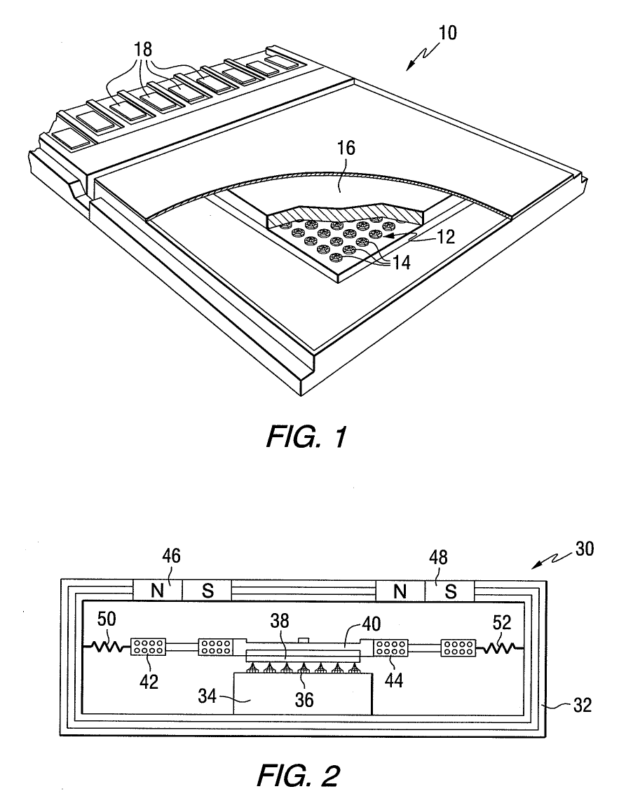

Referring to the drawings, FIG. 1 is a perspective view of a data storage device 10 that can be constructed in accordance with an aspect of the invention. In the storage device 10 of FIG. 1, an array 12 of transducers 14, also called probes, tips or heads, are positioned adjacent to a storage medium 16. The ends of the transducers 14 and a recording surface of the storage medium 16 lie in planes that are generally parallel to each other. The transducers 14 are electrically connected to connectors 18 through control circuitry, not shown. The storage medium 16 or the transducer array can be coupled to at least one actuator (not shown in this view), which is configured to move the storage medium 16 relative to array 12. This movement causes individual storage locations or domains on storage medium 16 to be moved relative to the transducers. Each transducer can include one or more electrodes. The storage medium in the example of FIG. 1 can be, for example, a ferroelectric, magnetic or optical storage medium. However, the invention is not limited to any particular type of storage medium.

FIG. 2 is a cross-sectional view of a probe storage device 30 that includes actuators and a suspension assembly for providing relative movement between the storage medium and an array of transducers. The device includes an enclosure 32, also referred to as a case, base, or frame, which contains a substrate 34. An array of transducers 36 is positioned on the substrate. In this example, the transducers extend upward to make contact with a storage medium 38. The storage medium 38 is mounted on a movable member, or sled 40. Relative movement between the storage medium and the transducers is provided by electromagnetic actuators that include coils and magnets. Coils 42 and 44 are mounted on the movable member. Magnets 46 and 48 are mounted in the enclosure near the coils. Springs 50 and 52 form part of a suspension assembly that supports the movable member. The enclosure 32 can be formed of, for example, injection molded plastic. While FIG. 2 shows one example of a data storage device, it will be recognized that other known types of suspensions and actuators can be used to position the components and to provide relative movement between the transducers and the storage medium. This invention is not limited to devices that use any particular type of transducer and storage medium positioning and/or actuating devices.

In ferroelectric probe storage devices, the transducers include an electrode that is used to subject the storage medium to an electric field. When the transducer makes contact with the storage medium and relative movement occurs between the transducer and the storage medium, a lateral friction force will be exerted on the tip of the transducer. The transducer electrode may lose contact with the storage medium as a result of transducer torsional movement.

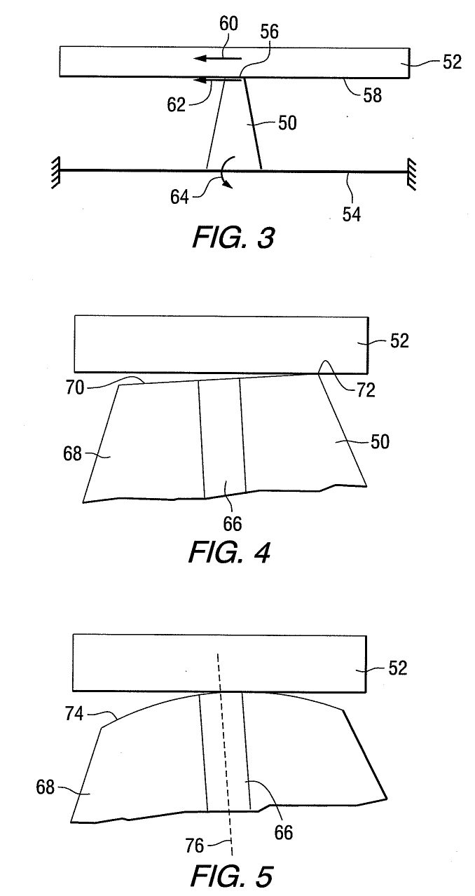

FIG. 3 is a schematic representation of a transducer 50 and an adjacent storage medium 52. The transducer is mounted on a spring assembly 54 and includes a tip, or end 56 that makes contact with a surface 58 of the storage medium. When the storage medium moves in the direction indicated by arrow 60, a friction force indicated by arrow 62 causes a rotational torque on the transducer as illustrated by arrow 64. If the force pushing the transducer against the storage medium is not big enough, the transducer tip will have a small rotation movement. This is illustrated schematically in FIGS. 4 and 5.

FIGS. 4 and 5 are schematic representations of a transducer tip and an adjacent storage medium. In the examples of FIGS. 4 and 5, the transducers include an electrode 66 positioned along a central axis 76, and a coating of wear-resistant material 68 that surrounds the electrode. The end of the electrode is exposed to allow electrical contact between the electrode and the storage medium. In FIG. 4, the transducer includes a flat end 70. Initially, the central axis is positioned substantially perpendicular, or normal, to the surface of the storage medium. However, as a result of frictional forces, the transducer can rotate such that the central axis is no longer normal to the surface of the storage medium. Rotation of the transducer will cause an edge 72 of the wear-resistant material to make contact with the storage medium. This may cause the electrode to lose contact with the storage medium.

When the transducer experiences rotational forces such that the axis 76 has a rotational moment on it at the interface, the contact stresses are non-uniform at the interface. That is, the leading edge corner will have a higher stress than the trailing edge. Thus any tilting can cause an intense edge contact. This in turn leads to a large contact stress variation and a high contact stress that increases the probability of wear.

Abrasive and adhesive wear are the main mechanisms of storage medium wear, except for catastrophic wear due to electrical shorting at the surface of the storage medium. For both wear mechanisms, the wear rate, which can also be expressed as the wear volume change with time, is directly proportional to the wear coefficient, the sliding speed, and the real contact area. Therefore, a smaller contact area can directly reduce the wear rate.

To reduce wear, the transducer tip interface can be made as small as possible so that the contact area between transducer and storage medium is smaller. A smaller contact area can also reduce the required loading force while maintaining electrical contact between the electrode and the storage medium. Lateral friction, which is directly proportion to the loading force, will also be reduced. Friction induced heating is reduced as well. For a 32 by 32 transducer array, the reduction of friction is critical to enable lateral read/write movements without consuming too much energy, which makes several servo designs feasible for this application.

In one aspect of this invention, the transducer tip is curved to form an interface where the edges of the wear-resistant material are rounded. In FIG. 5, the transducer includes a curved end 74. Thus the electrode will maintain contact with the storage medium, and the transducer will have a more uniform stress distribution. This will cause the transducer and storage medium to be less prone to wear. Tips having a relatively large radius of curvature (e.g., ˜0.5 mm) have been modeled. The modeling assumed a spherical radius of curvature, but the end of the electrode could have an asymmetric radius of curvature.

A curved interface forms a contact shape that produces a more uniform contact stress. Furthermore, the contact stress does not vary significantly even with tilting, since the contact is stable and tolerant to relative movement of the transducer and the storage medium. The small variation in contact stress results in a lower probability of the stress exceeding the yield strength of the transducer materials.

A curved interface can also reduce the probability of the electrode losing contact with the storage medium surface. A curved transducer surface and the surface of the storage medium form a geometrically conforming contact pair. It results in a stable contact with a natural tolerance to relative sliding/tilting without dramatically changing the contact characteristics such as contact area. Therefore, curved surface at transducer-storage medium interface can help to maintain stable contact of the electrodes and the storage medium.

In contrast, a flat-to-flat interface results in an unstable contact. A subtle variation of contact force can cause a dramatic change in contact characteristics, such as contact area shift. It can also cause the electrode to lose contact with the storage medium, which is evidenced by the contact model shown in FIG. 4.

In one aspect, the invention provides a transducer having curved interface to provide a stable electrical contact with a minimum required normal load. The tapered curved interface will provide a more uniform stress distribution on the contacting interface and a less concentrated stress zone in the storage medium, which are expected to result in less wear of transducer and storage medium. Additionally, if there is any wear of the transducer, the cross-sectional area of the conductive parts will not change, thus the electrical characteristics of the contact are stable over a longer period of time.

It is further desirable to design the structure so that the vertical motion of the transducer tip does not cause cross-track motion and undesirable wear. While the curved interface will be more resistant to mechanical wear, in another aspect, the invention provides a transducer assembly with a symmetric suspension.

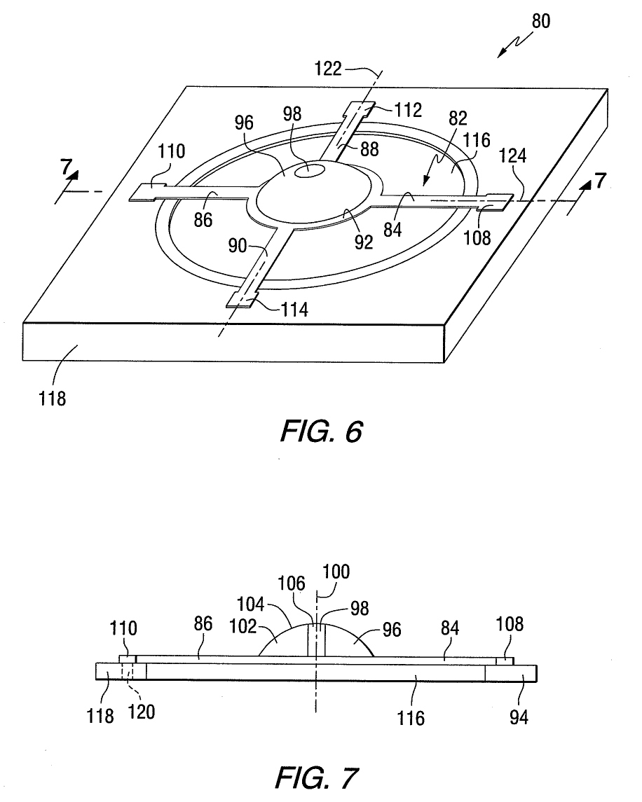

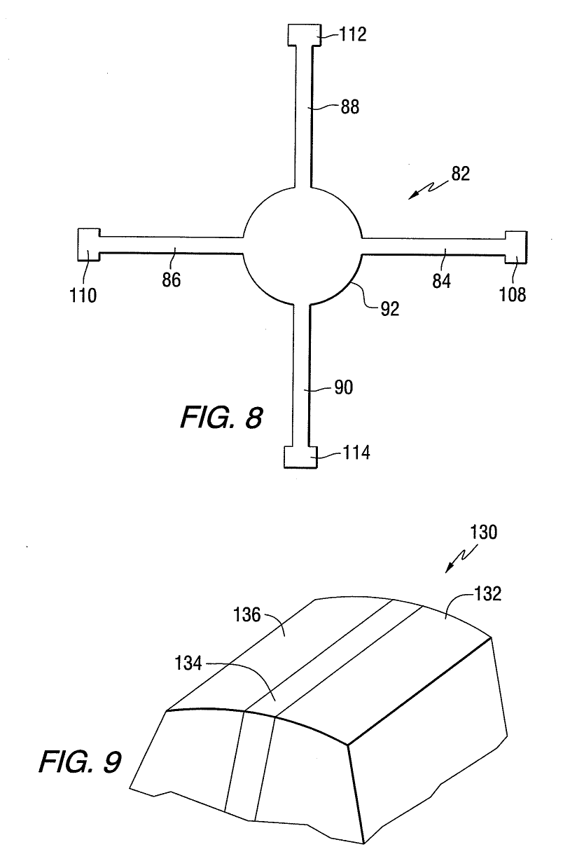

FIG. 6 is an isometric view of a transducer assembly 80 constructed in accordance with an aspect of the invention. FIG. 7 is a cross-sectional view of the transducer assembly of FIG. 6 taken along line 7-7. FIG. 8 is a plan view of the spring of the transducer assembly of FIG. 6.

In this example, the transducer assembly 80 includes a spring 82 having a plurality of arms 84, 86, 88 and 90 that extend from a transducer support base 92 to a frame 94. A transducer 96 is mounted on the transducer support base 92. The transducer includes an electrode 98 that is positioned along a central axis 100 of the transducer, and a wear-resistant material coating 102 that surrounds the electrode. The transducer includes a curved end 104, with an end 106 of the electrode being exposed for contact with an adjacent storage medium. At least one of the spring arms can be electrically conductive to provide an electrical connection between the electrode 98 and at least one of a plurality of contacts 108, 110, 112 and 114. Alternatively, at least one of the spring arms could be used to support a conductor that is electrically connected to the electrode. In one example, the frame can define an opening or cavity 116 and can be part of a substrate 118. The contacts can be connected to vias 120 that pass through the substrate to permit electrical connections on the bottom of the substrate. In another example, the frame can be fabricated integrally with the spring from a single layer of spring material.

In this example, the arms or beams of the spring are positioned along mutually perpendicular axes 122 and 124. Thus the spring forms a symmetric support structure. However, in principle the spring beams do not have to be perpendicular and the springs could include more, or less, than four beams. As used herein, a symmetric support structure is one where a vertical, referred as the Z-direction in Cartesian coordinates, load and displacement of the spring structure does not cause a displacement in the X or Y-directions.

The configuration of FIGS. 6, 7 and 8 has an advantage over previously proposed cantilever transducer designs in that it is symmetrical and anchored at multiple locations. Since it is symmetrical, it does not suffer from off-track motion. By being anchored at more than one end, it has more stability against lateral friction forces as well, providing higher and more symmetrical torsional stiffness.

To reduce off-track motion, in one example, a quaternary-ended spring assembly is provided in FIG. 6. Because each end of the flexible support structure (e.g., each spring member) is anchored, the assembly will mitigate the cross-track motion. While FIG. 6 shows four beam members, in principle the spring assembly could include more, or less, than four beam members.

The dielectric interface, that is the end surface of the dielectric material 68 in FIG. 5, can be formed on the electrode using a number of different processing methods. Materials that could be used for the dielectric interface include Al₂O₃ and Si₃N₄, but other dielectric materials could work as well.

A first example of the spring assembly uses a silicon-on-insulator (SOI) wafer as the substrate 118, with silicon spring arms 84, 86, 88 and 90 supported by an insulator. The top of the transducer that forms the recording interface would be separated from the spring with a predefined Z-spacing dimension. To maintain planarity during processing, an SOI wafer can be used where the spring material may be Si₃N₄ with a 15 μm thick Si single crystal layer on top. This structure can be fabricated by starting with a planarized layer suitable for fine feature lithography and then removing material, eventually fabricating a complete structure such as that shown in FIG. 6.

Another example uses a controlled deposition spacing layer. This example can be fabricated without the use of an SOI wafer, but merely a spring layer (e.g., Si₃N₄) that has a sacrificial layer beneath it. A method of maintaining planarity during the formation of the electrode and still maintaining a Z-spacing that could be 15 μm, starts with a flat underlying surface. A flat spacing control layer can be placed on the spring layer. The dielectric interface can be added on top of this flat layer, and then the spacing layer can be patterned on the dielectric interface. One deposition technique that could be used to deposit this is Plasma Enhanced CVD (PE-CVD). PE-CVD can be deposited with 5000 Å/min making it suitable for manufacturing. It also can be done at relatively low temperatures (e.g., ambient to ˜350° C.) that are compatible with underlying integrated circuit structures.

To define the interface features, it is desirable to have a planarized interface. This can be accomplished by adding planarization layers on which the top electrode is fabricated and then subsequently the top feature can be tapered.

The electrode could be mounted on a variety of spring configurations to provide Z-direction compliance. The interface can include both a wear-resistant material and a conductive material, both being in contact with the storage medium during the write and read operations. Thus, the transducer will provide both electrical contact and a minimum amount of wear during use. The wear-resistant material can be for example, diamond-like carbon, oxides (e.g., Al₂O₃, ZrO₂—Y₂O₃, HfO₂), or borides. The metal electrode can be chosen so that its mechanical properties match the mechanical properties of the wear-resistant layer, thus allowing for the same type of deformation in both materials at a certain mechanical stress. The conductive materials used for the electrode can be, for example, metallic carbides, metallic nitrides, or a hard metal such as Ru. In addition, a number of wear-resistant layers can be added subsequently to the electrode.

In FIG. 7, the end of the transducer is shown to have a spherical curvature. Other shapes are also within the scope of this invention. For example, FIG. 9 is an isometric view of a transducer 130 having an end 132 with a cylindrical curvature. In this example, the ends of both the electrode 134 and the wear-resistant coating 136 have a cylindrical curvature.

While particular examples have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. An apparatus comprising:
a storage medium;
a transducer including an electrode positioned along an axis and having a curved end positioned adjacent to the storage medium;
a wear-resistant coating surrounding the electrode; and
an actuator providing relative movement between the storage medium and the transducer.

2. The apparatus of claim 1, wherein the axis is positioned substantially normal to a surface of the storage medium.

3. The apparatus of claim 1, wherein the transducer is mounted on a symmetrical suspension.

4. The apparatus of claim 3, wherein the symmetrical suspension comprises:
a base; and
a plurality of spring arms extending radially from the base to a frame.

5. The apparatus of claim 4, wherein the spring arms lie along mutually perpendicular axes.

6. The apparatus of claim 1, wherein the curved end has a substantially spherical curvature.

7. The apparatus of claim 1, wherein the curved end has a substantially cylindrical curvature.

8. The apparatus of claim 1, further comprising:
a plurality of additional transducers, each including an electrode positioned along an axis and having a curved end positioned adjacent to the storage medium, and a wear-resistant coating surrounding the electrode.

9. An apparatus comprising:
a storage medium;
a transducer mounted on a symmetric suspension and positioned adjacent to the storage medium; and
an actuator providing relative movement between the storage medium and the transducer.

10. The apparatus of claim 9, wherein the symmetrical suspension comprises:
a base; and
a plurality of spring arms extending radially from the base to a frame.

11. The apparatus of claim 9, wherein the spring arms lie along mutually perpendicular axes.

12. The apparatus of claim 9, wherein the transducer comprises:
an electrode positioned along a central axis of each transducer; and
a wear-resistant material surrounding the electrode.

13. The apparatus of claim 9, wherein the transducer includes a curved end.

14. The apparatus of claim 13, wherein the curved end includes a spherical or cylindrical curvature.

15. The apparatus of claim 9, further comprising:
a plurality of additional transducers, each including an electrode positioned along an axis and having a curved end positioned adjacent to the storage medium, and a wear-resistant coating surrounding the electrode.

16. An apparatus comprising:
a transducer including an electrode positioned along an axis and having a curved end;
a wear-resistant material surrounding the electrode; and
a symmetric spring assembly supporting the transducer.

17. The apparatus of claim 16, wherein the symmetric spring assembly comprises:
a base; and
a plurality of springs extending from the base to a frame.

18. The apparatus of claim 17, wherein the springs lie along mutually perpendicular axes.

19. The apparatus of claim 17, wherein the curved end has a substantially spherical curvature.

20. The apparatus of claim 16, wherein the curved end has a substantially cylindrical curvature.
